(19) United States
(12) Patent Application Publication
(10) Pub. No.: US 2024/0062060 A1
(43) Pub. Date: Feb. 22, 2024

(54) SOLVING MIXED INTEGER PROGRAMS USING NEURAL NETWORKS

(71) Applicant: DeepMind Technologies Limited, (US)

(72) Inventors: Sergey Bartunov, London (GB); Felix Axel Gimeno Gil, London (GB); Ingrid Karin von Glehn, London (GB); Pawel Lichocki, Gdansk (PL); Ivan Lobov, St. Albans (GB); Vinod Nair, London (GB); Brendan Timothy O'Donoghue, London (GB); Nicolas Sonnerat, London (GB); Christian Tjandraatmadja, Cambridge, MA (US); Pengming Wang, London (GB)

(21) Appl. No.: 18/267,363

(22) PCT Filed: Dec. 20, 2021
(86) PCT No.: PCT/EP2021/086740

§ 371 Date: Jun. 14, 2023

Related U.S. Application Data
(60) Provisional application No. 63/127,978, filed on Dec. 18, 2020.

(51) Int. Cl. G06N 3/08; G06F 17/11

(52) U.S. Cl. CPC G06N 3/08; G06F 17/11

(57) ABSTRACT

Methods, systems, and apparatus, including computer programs encoded on computer storage media, for solving mixed integer programs (MIPs) using neural networks. One of the methods includes obtaining data specifying parameters of a MIP; generating, from the parameters of the MIP, an input representation; processing the input representation using an encoder neural network to generate a respective embedding for each of the integer variables; generating a plurality of partial assignments by selecting a respective second, proper subset of the integer variables; and for each of the variables in the respective second subset, generating, using at least the respective embedding for the variable, a respective additional constraint on the value of the variable; generating, for each of the partial assignments, a corresponding candidate final assignment that assigns a respective value to each of the plurality of variables; and selecting, as a final assignment for the MIP, one of the candidate final assignments.

### BACKGROUND

This specification relates to solving mixed integer programs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that solves a mixed integer program (MIP) using a neural network.

Particular embodiments of the subject matter described in this specification can be implemented so as to realize one or more of the following advantages.

Conventional Mixed Integer Programming solvers rely on an array of sophisticated heuristics developed with significant research to solve large-scale MIP instances encountered in practice. However, these solvers are very computationally intensive, not adapted to parallel processing hardware, and not able to automatically exploit shared structure among different MIP instances.

The techniques described in this specification, on the other hand, use a deep neural network to generate multiple partial assignments for the integer variables of a given MIP instance, and the resulting smaller MIPs for un-assigned variables are solved with a MIP solver to construct high quality joint assignments.

By using a deep neural network that has been trained on a set of training MIP instances, the system can leverage heuristics that have been learned by the deep neural network and that generalize to new MIP instances, improving the quality of the assignments generated for the new MIP instances.

Moreover, the described techniques are designed to leverage parallel processing hardware in order to effectively parallelize the generation of a final assignment for large-scale MIPs. In particular, the techniques are designed such that the MIP solver can be applied to each of the partial assignments independently, i.e., so that a respective candidate final assignment can be generated from each partial assignment independently. Additionally, the sampling required to generate any given partial assignment can also be performed in parallel for each assignment and, when the sampling is non-auto-regressive, the sampling required for individual variables within a given partial assignment can be further parallelized. Thus, the system can effectively distribute the workload required to solve the MIP among multiple parallel processing devices to decrease the time required to generate a solution. This is in contrast to conventional MIP solvers, which are not able to leverage parallel processing hardware and perform much of their computation in sequence.

Additionally, the neural network used to generate the partial assignments can be trained on all feasible assignments generated by running an MIP solver on a given a MIP instance and does not require that any of the assignments be the optimal solution for the MIP instance. Thus, training data for the model is easy to collect and the model can be trained to generate high quality placements even when relatively few MIP instances are present in the training data set.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example mixed integer program (MIP) solver system.

FIG. 2 shows an example of generating embeddings for the integer variables of an MIP.

FIG. 3 is a flow diagram of an example process for generating a final assignment for an MIP.

FIG. 4A is a flow diagram of an example process for generating an additional constraint for a binary variable for a given partial assignment.

FIG. 4B is a flow diagram of an example process for generating an additional constraint for a general integer variable for a given partial assignment.

FIG. 5 is a flow diagram of an example process for generating optimality gap data for an MIP.

FIG. 6 shows the performance of the described techniques relative to another MIP solving technique on a variety of MIP solving tasks.

FIG. 7 also shows the performance of the described techniques relative to the other MIP solving technique on the MIP solving tasks.

Like reference numbers and designations in the various drawings indicate like elements.

### DETAILED DESCRIPTION

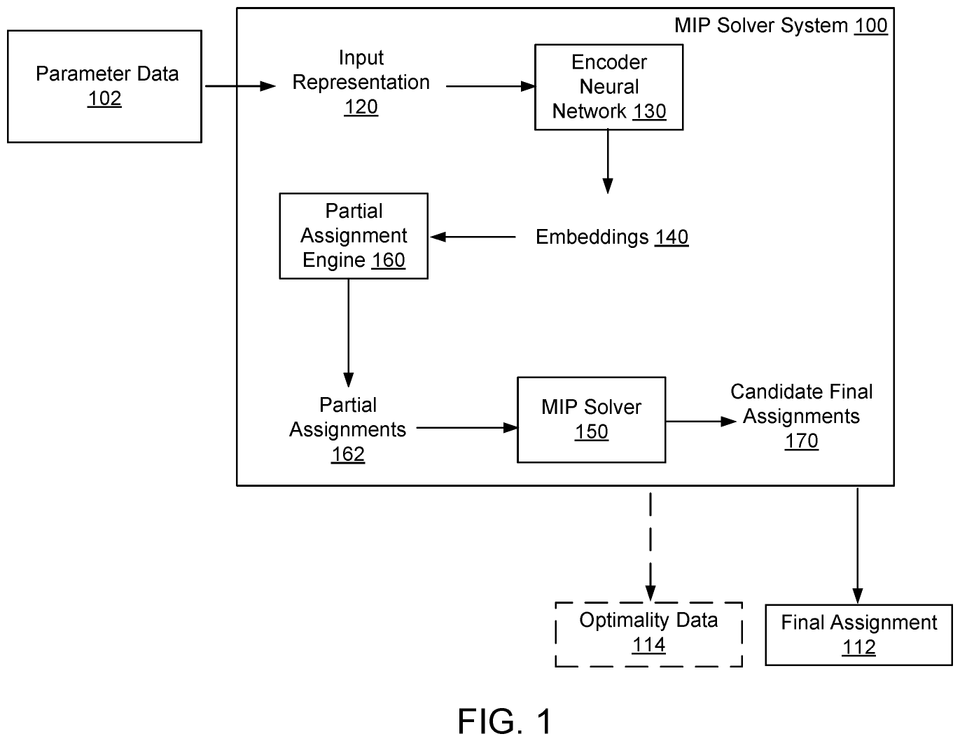

FIG. 1 shows an example mixed integer program (MIP) solver system 100. The MIP solver system 100 is an example of a system implemented as computer programs on one or more computers in one or more locations, in which the systems, components, and techniques described below can be implemented.

The system 100 is a system that receives as input parameter data 102 that specifies an MIP and generates as output a final assignment 112 that is a solution to the MIP. Optionally, the system can also generate as output optimality gap data 114 defining an optimality gap proof for the final assignment 112.

Generally, an MIP defines an optimization problem, e.g., a minimization problem, for assigning a respective value to each variable in a set of variables subject to a set of constraints on the values of the variables.

In particular, a MIP with n variables and m constraints has the form:
minimize c^{T}x
subject to Ax≤b
   l≤x≤u
   xᵢϵ [symbol] , iϵ [symbol] ,
      where xϵ [symbol] ⁿ is a vector of the variables, Aϵ [symbol] ^{m×n} is the constraint matrix that specifies the coefficients for each of the m constraints, bϵ [symbol] ^{m} specifies the constraint bound values for the m constraints, cϵ [symbol] ⁿ specifies the coefficients for the objective, i.e., the objective function coefficients, l is an n-component vector that specifies a respective lower bound for each of the variables, u, is an n-component vector that specifies the respective upper bound for each of the variables, [symbol] is the set of integers, and [symbol] is an index set of integer variables. An assignment for an MIP assigns a respective value to each of the set of variables.

An assignment that assigns a respective value to each of the set of variables such that the set of constraints on the values of the variables are satisfied will also be referred to as a “feasible” assignment.

Solving an MIP refers to generating an assignment that assigns a respective value to each of the set of variables such that the assignment is feasible and the objective is minimized. In other words, solving an MIP refers to identifying the candidate assignment that is feasible and has the lowest value of the objective of any candidate feasible assignment that is considered during a search for an optimal assignment. That is, “solving an MIP” does not necessarily imply obtaining the optimal assignment, i.e., the best possible feasible assignment, for which the objective has its lowest possible value (global minimum).

In addition to the set of constraints, as seen from the equation above, at least some of the variables in the set (i.e. a proper subset of the components of x, or all the components of x) are constrained to be integer variables, i.e., variables that are constrained to take only integer variables, as opposed to continuous variables that can take any value in some continuous range.

In some cases, all of the integer variables are binary variables, i.e., variables that can only take one of two possible integer values, e.g., zero or 1.

In other cases, at least some of the integer variables are only constrained to be general integers, i.e., variables that can take more than two values and, in particular, can take any integer value between the lower bound value for the variable and the upper bound value for the variable.

Thus, the parameter data 102 that is received as input by the system 100 includes parameters defining the objective to be minimized and the constraints that need to be satisfied. More specifically, the parameter data 102 specifies the number of variables, the number of constraints, the coefficients for the objective, the coefficient values and the constraint bound values for the constraints, the respective upper and lower bounds for each of the variables, and the integer set of variables that are constrained to be integers.

The MIP that is being solved can represent any of a variety of real-world, technical optimization problems, e.g., bin packing, capacity planning, resource allocation, factory operations, compute workloads, datacenter optimization, even scheduling, computer network traffic routing, automotive traffic routing, flight scheduling, and many others. In particular, solving the MIP may amount to performing a control method of allocating one or more real-world resources (such as computing resources or hardware resources (items of equipment)), to perform one or more corresponding components of a real-world task, e.g. during specific time periods. Following the solution of the MIP, there may be a step of transmitting control instructions, based on the solution, to the real-world resources (e.g. in the case of real-world resources which are computing resources, to one or more computer systems and/or memory units which implement those resources), thereby controlling the resources to perform the allotted components of the task.

That is, the present disclosure also discloses a control system including the mixed integer program (MIP) solver system 100 (implemented by one or more computer systems), and a control unit for generating control instructions based on solutions provided by the solver system 100 and transmitting them to the real-world resources, e.g., transmitting instructions to one or more data centers to cause the data centers to allocate capacity or resources to certain services, e.g., software services, database shards, and so on, within the data centers according to the solution of the MIP. It further discloses a system including the control system and the real-world resources.

As one example, the variables in the MIP can represent components of an industrial facility and the values for the components can indicate a setting for the component, e.g., whether the component is active at any given time. As a particular example, the variables can represent generators, e.g., power plants or other components that generate electricity on an electric grid, and the MIP attempts to minimize some efficiency metric while meeting demands for energy on the energy grid.

As another example, the MIP can represent a logistics problem, e.g., assigning resources to modes of transportation to ensure that the resources are routed to meet certain requirements. As a particular example, the MIP can represent an assignment of pieces of cargo among multiple flights to minimize delivery times while satisfying certain constraints.

As another example, the MIP can represent the verification of the predictions of a neural network, i.e., can measure how robust the predictions are to perturbations in the input. For example, the neural network may be one configured, upon receiving input which is an image (e.g. captured by a camera) or an audio signal (e.g. captured by a microphone), and/or features obtained from an image or audio signal, to output a label which indicates that the content of the image/audio signal is in at least one of a set of categories; that is, the image/audio signal is classified. In this case, the MIP can correspond to an input to the neural network, e.g., an image or audio signal, and the MIP can attempt to minimize the amount of noise that needs to be added to the input, constrained by the requirement that the neural network has to assign an incorrect label to the resulting noisy input, i.e., a label that is different than the label assigned to the neural network for the original input.

As another example, the MIP can represent the allocation of data across multiple storage locations to minimize some metric, e.g., overall storage capacity consumed, while satisfying certain constraints, e.g., on the latency required for any of a set of computer resources or services to access any of the data. As a particular example, the MIP can represent the sharding of a search engine index database (or other database that is queried from many different locations) across multiple storage cells, e.g., datacenters, in different geographic locations. As another particular example, the MIP can represent how to store the shard(s) of a database that are assigned to a given data center across the machines, the storage locations available, or both within the data center.

As another example, the MIP can represent the allocation of computational resources across multiple computing components of a computing system to maximize efficiency, e.g., to minimize the total amount of resources consumed, subject to constraints on the performance of the computing system.

As a particular example, the MIP can represent assigning respective capacities to each of a plurality of data centers in different geographic locations.

As another particular example, the variables in the MIP can represent software service—data center pairs and the value assigned to a given variable can represent an amount of computational resources that are allocated to a given service in the given data center. The constraints can represent constraints on total resources assigned to each service, latency for responding to requests for one or more of the services in one or more geographic regions, a level of redundancy required for a given service in a given geographic region, and so on.

Generally, to generate the final assignment 112, the system 100 generates, from the parameters of the MIP, an input representation 120 that represents the MIP in a format that can be processed by a neural network.

The system 100 then processes the input representation 120 using an encoder neural network 130 to generate a respective embedding 140 for each of the integer variables, i.e., for each of the variables in the subset of variables that are constrained to be integers. An embedding, as used in this specification, is an ordered collection of numeric values, e.g., a vector of floating point values or other numeric values that has a fixed dimensionality.

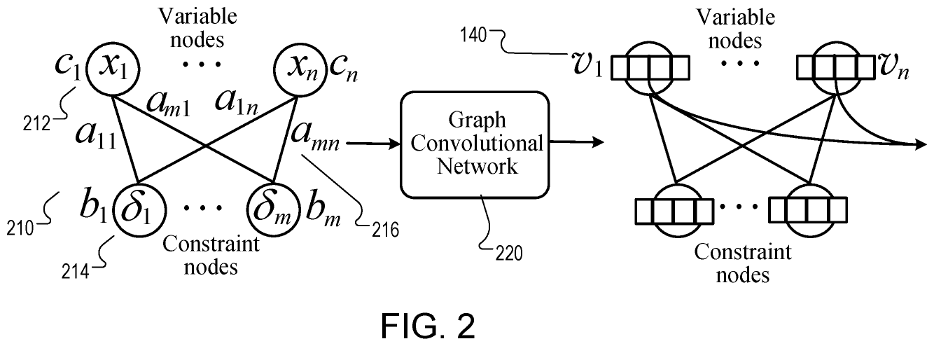

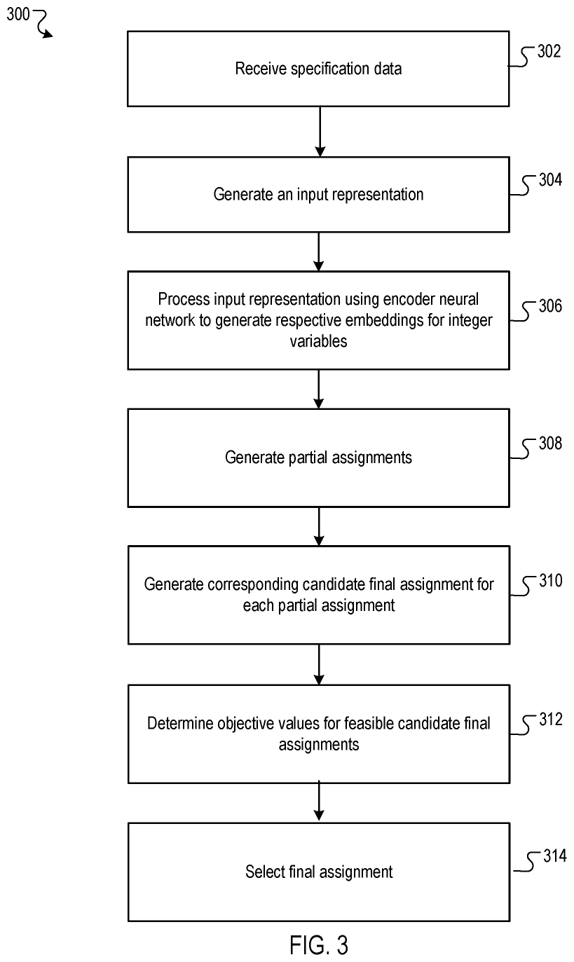

Generating the input representation 120 and processing the input representation 120 to generate the respective embeddings 140 will be described in more detail below with reference to FIGS. 2 and 3.

The system 100 generates the final assignment using the respective embeddings 140 and an MIP solver 150.

The MIP solver 150 can be any appropriate MIP solver, e.g., a heuristic-based MIP solver, that solves an input MIP starting from a set of input constraints. Examples of heuristic-based MIP solvers that can be used by the system 100 include SCIP (Gamrath et al. 2020), CPLEX (IBM ILOG CPLEX 2019), Gurobi (Gurobi Optimization 2020), and Xpress (FICO Xpress 2020).

More specifically, a partial assignment engine 160 within the system 100 uses the respective embeddings 140 and one or more neural networks to generate a plurality of partial assignments 162 that impose additional constraints on the values of some or all of the integer variables. For example, the partial assignments 162 that the engine 160 generates can specify exact values for one or more of the variables, larger lower bounds, smaller upper bounds or both for one or more of the variables, or some combination.

Thus, each partial assignment 162 defines a smaller MIP that has the constraints specified in the parameter data 120 and one or more additional constraints that are defined by partial assignment 162 generated by the engine 160. Here the term “smaller” is used to mean “more tightly constrained”, e.g. the space of possibilities from which the set of variables must be selected is a proper subset of the space of possibilities defined by the constraints defined by the parameter data 102.

Generating the partial assignments 162 is described in more detail with reference to FIGS. 2 and 3.

The system 100 then uses the MIP solver 150 to solve each smaller MIP, i.e., to solve the respective smaller MIP that is specified by each partial assignment 162, to generate a respective candidate final assignment 170 for each partial assignment 162 that assigns a respective value to each of the plurality of variables starting from the additional constraints in the partial assignment 162.

The system 100 then selects, as the final assignment 112 for the MIP, a candidate final assignment 170 that (i) is a feasible solution to the MIP and (ii) has the smallest value of the objective of any of the candidate final assignments 160 that are feasible solutions to the MIP.

As will be described below, the generating of the corresponding candidate final assignments 170 (and the sampling that is required to generate the partial assignments 162 from the respective embeddings) can be performed in parallel for each smaller MIP, greatly reducing the time required to generate the final assignment 112 for the MIP.

In some implementations, the system 100 can also generate the output optimality gap data 114 defining an optimality gap proof for the final assignment 112.

An optimality gap proof specifies a proven bound on the gap in objective value between the final assignment 112 and an optimal assignment, i.e., the best possible feasible assignment, and can be used to verify the quality of the final assignment 112, i.e., because better final assignments 112 will have smaller bounds on the objective value gap while worse final assignments 112 will have larger bounds on the objective value gap.

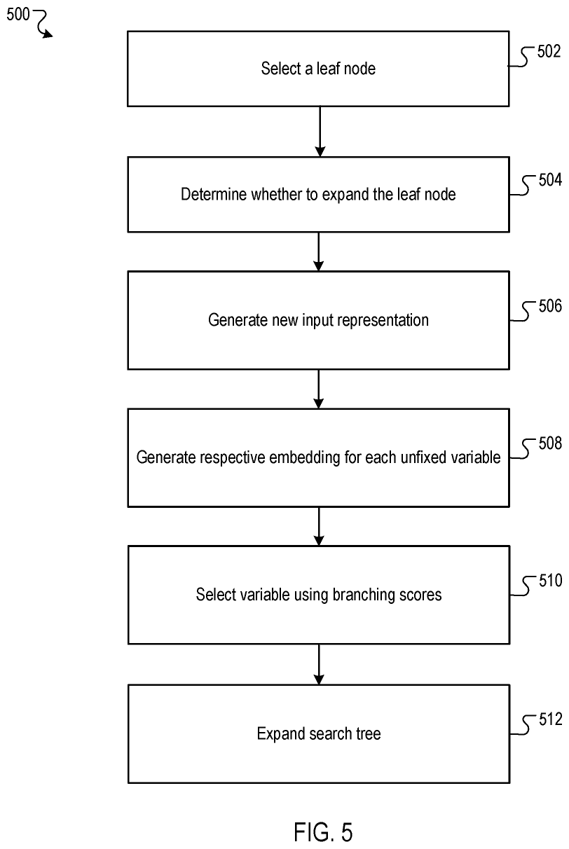

Generating the optimality gap data 114 will be described in more detail below with reference to FIG. 5.

Prior to using the encoder neural network 120 and the neural network(s) employed by the engine 160, the system 100 or another training system trains these neural networks on training data that includes for each of a plurality of training MIPs, (i) parameters specifying the MIP and (ii) one or more feasible assignments for the MIP. For example, the feasible assignments can have been generated by the MIP solver 150 or by another heuristic-based solver. Advantageously, the feasible assignments are not required to be optimal (or to approach being optimal). That is, the system 100 or the training system can train the neural networks to generate high quality assignments even if the training data includes many sub-optimal but feasible assignments, allowing for a much wider range of assignments to be used and training data to be much more readily collected, i.e., because generating a feasible assignment is much easier than searching for an optimal assignment.

FIG. 2 shows an example of generating embeddings 140 for the integer variables of an MIP.

As shown in FIG. 2, a system, e.g., the MIP solver system 100 of FIG. 1, receives specification data that specifies the parameters of the MIP and generates an input representation of the MIP from the specification data.

In particular, the input representation is a representation of a bipartite graph 210 that specifies the MIP.

The bipartite graph 210 includes a first set of variable nodes 212 that each represent one of the plurality of variables for the MIP and a second set of constraint nodes 214 each representing one of the constraints for the MIP.

The bipartite graph also includes, for each constraint node, a respective edge 216 from the constraint node 214 to each variable node 212 that represents a variable that appears in the constraint represented by the constraint node 214.

The input representation, i.e., the representation of the bipartite graph 210, includes one or more respective features for each of the plurality of nodes, i.e., for each of the variable nodes 212 and the constraint nodes 214, and an adjacency matrix that represents connectivity between the variable nodes 212 and the constraint nodes 214 in the bipartite graph.

The respective features for each of the variable nodes 212, include a representation of, e.g., an embedding of, a one-hot representation of, or a scalar representation of, the objective function coefficient of the variable represented by the variable node 212 and, optionally, a representation of the upper and lower bounds for the value of the variable represented by the variable node. The features can optionally additionally include a feature that encodes what type of variable the node represents, e.g., binary variable, general integer variables. Additionally, the features can also include feature derived from solving an LP relaxation of the MIP. The LP relaxation of the MIP is the problem which would result by removing from the original MIP the constraint that some of the variables are integers. The LP relaxation can be easily and efficiently solved through linear programming. The features derived from solving an LP relaxation can include features specifying the value assigned to the variable represented by the node by the solution to the LP relaxation, feature specifying the fractionality of the value assigned to the variable represented by the node by the solution to the LP relaxation, and so on. Optionally, some or all of these features can be normalized across the variable nodes.

The respective features for each of the constraint nodes 214 include a representation of the constraint bound value of the constraint represented by the constraint node 214. As another example, the features can optionally additionally include a feature representing a cosine similarity of the constraint coefficient vector with the objective coefficient vector. Additionally, the features can also include feature derived from solving an LP relaxation of the MIP, e.g., a tightness indicator for the constraint in the solution, a dual solution value for the constraint, and so on. Optionally, some or all of these features can be normalized across the constraint nodes.

In particular, the adjacency matrix is an N×N matrix, where N is the total number of nodes in the bipartite graph (counting both the n variable nodes 212 and the m constraint nodes 214).

In some implementations, an entry (i,j) in the adjacency matrix is (a) equal to 1 if a node with index i in an ordering of the nodes is connected to a node with index j in the ordering by an edge and (b) equal to 0 if i is not equal to j and if the node with index i is not connected to the node with index j by an edge. An entry (i,j) in the adjacency matrix (i.e. a diagonal entry) can be equal to 1.

In some other implementations, the system incorporates additional information about the constraints into the adjacency matrix by having the entries in the adjacency matrix represent normalized coefficients in the constraints for the MIP. Specifically, in these implementations, for the i-th variable and the j-th constraint, their two corresponding entries in the adjacency matrix, i.e., the entry (i,j) and the entry (j,i), are both set to aⱼᵢ, where aⱼᵢ is the coefficient at row j and column i of the constraint matrix for the MIP after the coefficients have been normalized. This results in edges weighted by the entries of the constraint matrix for the MIP rather than binary 1s and 0s.

The system then processes the input representation, i.e., the representation of the bipartite graph 210, using an encoder neural network 220 to generate a respective embedding for each of the variables in the integer subset, i.e., for each of the variables that are constrained to be integer-valued.

In the example of FIG. 2, the encoder neural network 220 is a graph neural network that is configured to process the features for each of the plurality of nodes through a sequence of one or more graph layers to generate the embeddings for the variables in the integer subset.

Each of the graph layers is configured to receive as input a respective input embedding for each of the nodes in the graph and generate as output a respective output embedding for each of the nodes in the graph.

For the first graph layer in the sequence, the input embedding for each of the nodes includes the features for the nodes from the representation of the graph 210. For each subsequent graph layer in the sequence, the input embedding for each of the nodes is the output embedding for the node generated by the preceding layer in the sequence.

The system then uses, for each variable in the integer subset, the output embedding generated by the last graph layer in the sequence for the node representing the variable as the output embedding for the variable.

More specifically, each graph layer is configured to apply an update function to each of the input embeddings to generate an updated embedding and then apply the adjacency matrix to the updated embeddings to generate initial output embeddings, i.e., by multiplying the adjacency matrix with a matrix that has the updated embeddings as the rows of the matrix.

Generally, the update function can be any learned function that can be applied independently to each embedding. For example, the update function can be a multi-layer perceptron (MLP) or other neural network.

In some implementations, the initial output embeddings are the output embeddings for the graph layer.

In some other implementations, each graph layer can also be configured to combine the initial output embeddings generated by the graph layer and the input embeddings for the graph layer to generate the output embeddings for the graph layer. For example, the graph layer can concatenate, for each node, the initial output embedding for the node and the input embedding for the node to generate the output embedding for the node. As another example, the graph layer can concatenate, for each node, the initial output embedding for the node and the input embedding for the node and then apply a normalization, e.g., LayerNorm, to the concatenated embeddings to generate the output embeddings for the layer.

By using the bipartite graph representation of the MIP as the input representation and having the encoder neural network be a graph neural network, the system ensures that the network output, i.e., the embeddings of the integer variables, is invariant to permutations of variables and constraints, and that the network can be applied to MIPs of different sizes using the same set of parameters. Both of these are important because there may not be any canonical ordering for variables and constraints, and different instances within the same application can have different number of variables and constraints. That is, employing the above architecture ensures that the system can generalize to MIPs with different sizes and different orderings of variables and constraints after training.

The system then uses the output embeddings 140 for the integer variables generated by the graph neural network to generate the final assignment 112 for the MIP.

This will be described in more detail below with reference to FIG. 3.

FIG. 3 is a flow diagram of an example process 300 for generating a final assignment for an MIP. For convenience, the process 300 will be described as being performed by a system of one or more computers located in one or more locations. For example, a MIP solver system, e.g., the MIP solver system 100 of FIG. 1, appropriately programmed, can perform the process 300.

The system receives specification data that specifies parameters of the MIP (step 302) and generates, from the parameters of the MIP, an input representation (step 304), e.g., as described above with reference to FIG. 2.

The system processes the input representation using an encoder neural network to generate a respective embedding for each of the variables in a first subset of the variables, i.e., for each of the integer variables that are constrained to be integer-valued (step 306). For example, the system can process the input representation using a graph neural network as described above to generate the respective embeddings for the integer variables.

The system generates a plurality of partial assignments (step 308).

In particular, the system can generate a fixed number of partial assignments.

For each partial assignment, the system can generate the partial assignment by first selecting a respective second, proper subset of the first subset of variables, i.e., of the integer variables, and then, for each of the variables in the respective second subset, generate, using at least the respective embedding for the variable, a respective additional constraint on the value of the variable. The second subset is referred to as a “proper” subset because it contains less than all of the integer variables.

For a given partial assignment, the system can select the respective proper subset of integer variables in any of a variety of ways.

For example, the system can randomly select a fixed size proper subset of the integer variables.

As another example, the system can use one or more assignment neural network heads to select the proper subsets for the partial assignments. A neural network “head” is a collection of one or more neural network layers. For example, each assignment neural network head can be an MLP.

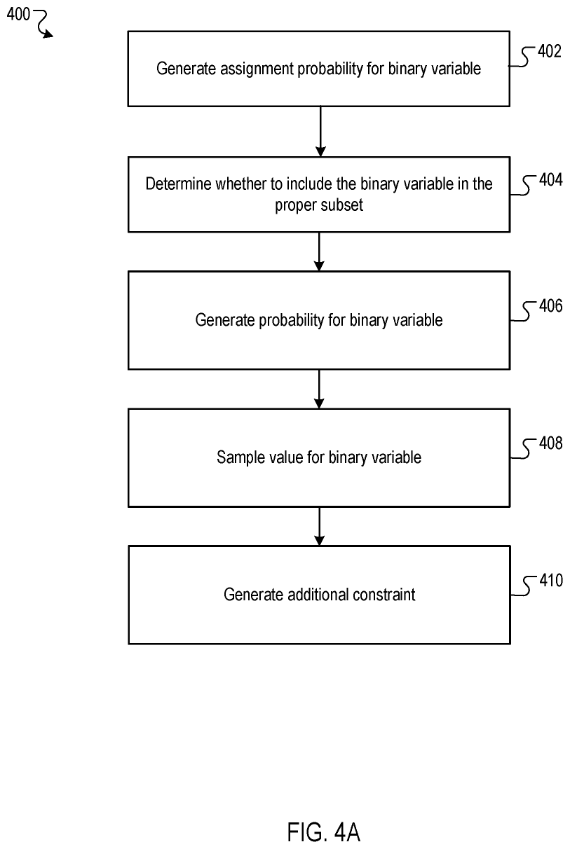

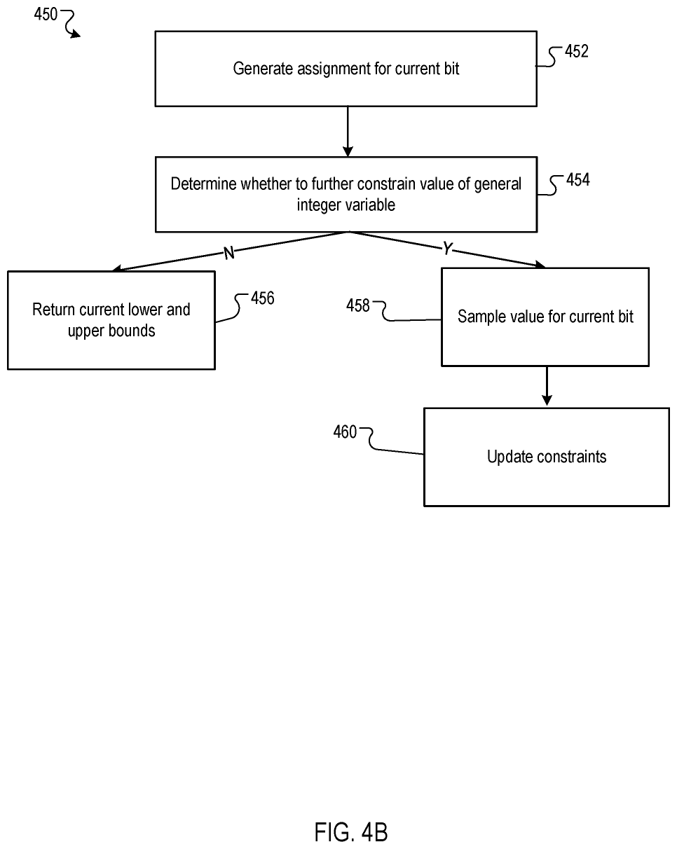

Using an assignment neural network head to select a proper subset of the integer variables is described in more detail below with reference to FIGS. 4A and 4B.

Once the system has selected the proper subset or a given partial assignment, the system generates, for each variable in the proper subset, respective additional constraints on the value of the variable from at least the embedding for the variable using a corresponding prediction neural network head.

Generally, when a given integer variable in the proper subset is a binary variable that can only take two possible integer values, the system generates an additional constraint that specifies the exact value of the integer variable.

Generating additional constraints for binary variable is described below with reference to FIG. 4A.

Generally, when a given integer variable in the proper subset is a general integer variable that can take more than two possible integer values, i.e., can take any value between a specified lower bound a specified upper bound, the system can either generate an additional constraint that specifies the exact value of the integer variable or can generate an additional constraint that specifies a reduced range for the integer variable, i.e., an additional constraint that increases the lower bound, reduces the upper bound, or both for the integer variable.

Generating additional constraints for general integer variables is described below with reference to FIG. 4B.

The system generates, for each of the plurality of partial assignments, a corresponding candidate final assignment (step 310).

Each candidate final assignment assigns a respective value to each of the plurality of variables starting from the additional constraints in the corresponding partial assignment. That is, the final value assigned to each variable by the candidate final assignment satisfies not only the initial constraints specified in the parameter data but also the additional constraints specified for the integer variables in the corresponding proper subset by the corresponding partial assignment.

In particular, the system can generate each corresponding candidate final assignment using a heuristic-based MIP solver conditioned on the parameters of the MIP and the additional constraints in the partial assignment.

In some implementations, because the heuristic-based MIP solver generates each candidate final assignment independently of each other candidate final assignment, the system generates the corresponding candidate final assignments in parallel, i.e., independently of one another and at the same time. For example, the system can assign each partial assignment to a corresponding different hardware resource, e.g., to a different computer, to a different processor, to a different ASIC, e.g., a different graphics processing unit (GPU) or a tensor processing unit (TPU), or to a different core of one or more multi-core processors, and use the corresponding hardware resource to generate the corresponding candidate final assignment using a separate instance of the heuristic-based MIP solver. Moreover, as will be evident from the descriptions of FIGS. 4A and 4B, generating the partial assignments can also be performed in parallel once the embeddings of the integer variables are generated. Thus, in some implementations, the hardware resources also generate the partial assignments in parallel, e.g. each by a corresponding different hardware resource, optionally with the same hardware resource being assigned both the task of generating a given partial assignment and the task of generating the corresponding candidate final assignment for the given partial assignment.

The system determines, for each candidate final assignment that is a feasible solution to the MIP, a respective value of the objective (step 312). That is, the system determines, for each candidate final assignment, whether the assignment is a feasible solution to the MIP by checking if the values in the candidate final assignment satisfy each of the constraints and, if so, computes the values of the constraints for the candidate final assignment, i.e., by computing a weighted sum of the values with each value being weighted by the corresponding objective coefficient. If the assignment is not a feasible solution, the system can discard the candidate final assignment.

The system selects, as the final assignment for the MIP, a candidate final assignment that (i) is a feasible solution to the MIP and (ii) has a smallest value of the objective of any of the candidate final assignments that are feasible solutions to the MIP (step 314).

FIG. 4A is a flow diagram of an example process 400 for generating an additional constraint for a binary variable for a given partial assignment. For convenience, the process 400 will be described as being performed by a system of one or more computers located in one or more locations. For example, a MIP solver system, e.g., the MIP solver system 100 of FIG. 1, appropriately programmed, can perform the process 400.

For each partial assignment, the system can perform the process 400 for each binary variable in the set of integer variables to first determine whether to include the binary variable in the proper subset for the partial assignment and then, if so, determine the additional constraint for the binary variable.

Moreover, the system can perform the process 400 in parallel for each of the partial assignments.

For each binary variable in the set of integer variables, the system generates, by processing at least the respective embedding for the binary variable using a corresponding assignment neural network head, an assignment probability for the binary variable (step 402).

As a particular example, the assignment neural network head can be an MLP that processes the embedding for a given binary variable to generate as output a value that defines the assignment probability. For example, the MLP can directly output the assignment probability. As another example, the value can define the success probability of a Bernoulli distribution, such that the success probability is equal to 1/(1+exp(−y_{d}), where y_{d} is the value output by the MLP.

In some cases, the system uses only a single assignment neural network head, i.e., each partial assignment corresponds to the same assignment neural network head.

In some other cases, each partial assignment corresponds to a respective assignment neural network head in a set of multiple assignment neural network heads. Each of the multiple assignment neural network heads have been trained to generate assignment probabilities that result in different expected coverages of the first subset, i.e., of the subset of integer variables. As a particular example, each partial assignment can correspond to a different assignment neural network head that has been trained to generate assignment probabilities that result in different expected coverages than each other assignment neural network head. Here the “coverage” of the subset of integer values is a value indicative of the proportion of the subset of integer variables which are assigned. For example, it may be defined as the ratio of the number of the integer variables which are assigned to those not assigned.

For each binary variable, the system then determines whether to include the binary variable in the respective proper subset in accordance with the assignment probability for the binary variable (step 404). That is, the system determines to include the binary variable with a probability equal to the assignment probability and determines not to include the binary variable with a probability equal to one minus the assignment probability.

For each binary variable that was selected for inclusion in the respective proper subset, the system generates, by processing at least the respective embedding for the binary variable using a corresponding prediction neural network head, a probability for the binary variable (step 406).

In some cases, the system uses only a single prediction neural network head, i.e., each partial assignment corresponds to the same prediction neural network head.

In some other cases, each partial assignment corresponds to a respective prediction neural network head in a set of multiple prediction neural network heads. In particular, in some implementations where the system uses multiple assignment neural network heads, each prediction neural network head can correspond to one of the assignment neural networks heads, i.e., so that each partial assignment corresponds to a respective pair of assignment—prediction heads. In these cases, each prediction head has been trained jointly with the corresponding assignment head as part of the training of the assignment head, as will be described in more detail below.

In yet other cases, when there are multiple assignment heads, there is still only a single prediction head.

As a particular example, the corresponding prediction neural network head can be an MLP that processes the embedding for a given binary variable to generate as output a value that defines the probability. For example, the MLP can directly output the probability. As another example, the value can define the success probability of a Bernoulli distribution, such that the success probability is equal to 1/(1+exp(−t_{d}), where t_{d} is the value output by the MLP.

For each binary variable that was selected for inclusion in the respective proper subset, the system then samples a value for the binary variable according to the probability for the binary variable (step 408) and generates an additional constraint that constrains the value of the binary variable to be equal to the sampled value (step 410). For example, the system can sample the higher of the two values that the binary variable can take with a probability equal to the probability generated by the prediction head and sample the lower value with a probability equal to one minus the probability generated by the prediction head or vice versa.

FIG. 4B is a flow diagram of an example process 450 for generating an additional constraint for a general integer variable for a given partial assignment. For convenience, the process 450 will be described as being performed by a system of one or more computers located in one or more locations. For example, a MIP solver system, e.g., the MIP solver system 100 of FIG. 1, appropriately programmed, can perform the process 450.

For each partial assignment, the system can perform the process 450 for each general integer variable in the set of integer variables to first determine whether to include the variable in the proper subset for the partial assignment and then, if so, determine the additional constraint for the general integer variable.

Moreover, the system can perform the process 450 in parallel for each of the partial assignments.

For general integer variables, the system operates on a sequence of bits that represents the cardinality of the general integer variable, i.e. a binary representation of the difference between the upper bound and the lower bound for the integer variable.

For each general integer variable in the set of integer variables, the system proceeds starting from the most significant bit in the sequence.

Generally, for each general integer variable, the system generates, by processing at least the respective embedding for the general integer variable using a corresponding assignment neural network head, i.e., the assignment neural network head corresponding to the given partial assignment, a respective assignment probability for each of one or more bits in the sequence of bits.

The system then determines whether to include the binary variable in the respective proper subset in accordance with the assignment probability for the most significant bit in the sequence.

If the system decides to include the binary variable in the proper subset, the system determines how many bits to include in the one or more bits for which values are sampled based on the respective assignment probabilities. The system then uses the sampled values for the one or more bits to generate the additional constraints on the value of the general integer variable.

This process is described in more detail below with reference to steps 452-460.

In particular, the system generates, by processing at least the respective embedding for the general integer variable using the corresponding assignment neural network head, an assignment probability for the current bit in the sequence (step 452). In some cases, the system performs the processing independently for each bit in the sequence. In these cases, the input to the assignment neural network head can include the respective embedding and an identifier of the index of the bit in the sequence. In other cases, the system performs the processing auto-regressively. In these cases, the input to the assignment neural network head can include the respective embedding, the identifier, and data derived from the processing of the preceding bit.

The system then determines whether to further constrain the value of the general integer variable based on the assignment probability (step 454).

In response to determining not to further constrain the value of the general integer variable, the system returns the current upper and lower bounds as the constraints for the general integer variable (step 456). Thus, when the system determines not to further constrain the value after processing only the most significant bit in the sequence for a given general integer variable, the system effectively determines not to include the variable in the respective second subset in accordance with the assignment probability for the most significant bit in the sequence.

In response to determining to further constrain the value of the general integer variable, the system generates, by processing at least the respective embedding for the general integer variable using the corresponding prediction neural network head, a probability for the current bit and samples a value for the current bit according to the probability (step 458). In some cases, the system performs the processing independently for each bit in the sequence. In these cases, the input to the prediction neural network head can include the respective embedding and an identifier of the index of the bit in the sequence. In other cases, the system performs the processing auto-regressively. In these cases, the input to the prediction neural network head can include the respective embedding, the identifier, and data derived from the processing of the preceding bit.

The system then updates the constraints on the value of the general integer variable based on the sampled value (step 460). That is, the system determines whether to increase the current lower bound or decrease the current upper bound based on which value is sampled for the bit.

For example, if the value for the bit is 1, the system can increase the current lower bound by adding, to the current lower bound, a value that is equal to the ceiling of (ub−lb)/2, where ub is the current upper bound and lb is the current lower bound.

As another example, if the value for the bit is 0, the system can decrease the current upper bound by subtracting, from the current upper bound, a value that is equal to the floor of (ub−lb)/2.

In some implementations, the system continues performing the process 450 until either a value has been sampled for all of the bits in the sequence or until the system determines not to further constrain the value of the variable in step 456. In these implementations, when the system has sampled a respective value for all of the bits in the sequence, the sampled values define a single value for the general integer variable, i.e., the additional constraints specify an exact value for the general integer value. When the one or more bits for which values are sampled include only a proper subset of the sequence of bits that includes the one or more most significant bits in the sequence, the sampled values define a range of values for the general integer variable, and the additional constraint constrains the general integer to have a value that is in the range of values defined by the sampled values for the most significant bits.

In some other implementations, the system maintains a threshold value that specifies the maximum number of bits for which values can be sampled. If the sequence includes more than the threshold number of bits, the system will terminate the process 450 after values for the threshold number of bits have been sampled even though additional bits remain and the system has not yet determined not to further constrain the value of the variable. Thus, in these implementations, general integer variables for which the cardinality results in a sequence of bits that is longer that the threshold value will always have their values constrained to be in a range of multiple integers rather than to an exact value.

As described above, prior to using the encoder neural network, the assignment neural network head(s), and the prediction neural network head(s) to generate assignments for new MIPs, the system trains the neural networks on training data.

The training data includes, for each of a plurality of training MIPs, (i) parameters specifying the MIP and (ii) one or more feasible assignments for the MIP. For example, the feasible assignments can have been generated by the MIP solver or by another heuristic-based solver. Advantageously, the feasible assignments are not required to be optimal (or to approach being optimal). That is, the system or the training system can train the neural networks to generate high quality assignments even if the training data includes many sub-optimal but feasible assignments, allowing for a much wider range of assignments to be used and training data to be much more readily collected, i.e., because generating a feasible assignment is much easier than searching for an optimal assignment. As a particular example, the feasible assignments for a given training MIP can include all of the feasible assignments that were produced by the heuristic-based solver while searching for the final assignment for the training MIP, i.e., using only the solver to solve the MIP from scratch without employing any of the above techniques. Thus, the feasible assignments for a given MIP will include many feasible but sub-optimal assignments in addition to the best assignment found by the solver.

In particular, the system trains the neural networks on the training data to optimize an objective function that (i) encourages the prediction head to generate probabilities that result in higher quality assignments while (ii) encouraging each assignment head to generate assignment probabilities that result in proper subsets with the corresponding coverage level (that is, a desired proportion of the variables, or specifically the integer variables, are assigned).

As a particular example, the system can train the neural networks using an appropriate supervised learning technique to minimize the following loss function L:

$$L = {\sum }_{i = 1}^{N} {\sum }_{j = 1}^{{N}_{i}} {w}_{i , j} \cdot l ( θ , {x}^{i , j} , {M}_{i} ) ,$$

$$l ( θ , {x}^{i , j} , {M}_{i} ) = \frac{- {\sum }_{d ϵ𝒥} log {p}_{θ} ( {x}_{d}^{i , j} \vert {M}_{i} ) \cdot {y}_{d}^{i , j}}{{\sum }_{d ϵ𝒥} {y}_{d}^{i , j}} + λΨ ( C - \frac{1}{\vert 𝒥 \vert} {\sum }_{d ϵ𝒥} {y}_{d}^{i , j} ) , and$$

$${w}_{i , j} = \frac{exp ( - {c}_{i}^{T} {x}^{i , j} )}{{\sum }_{k = 1}^{{N}_{i}} exp ( - {c}_{i}^{T} {x}^{i , k} )} ,$$

where N is the number of training MIPs in a batch of training data, i is an integer index, Mᵢ is the i-th MIP in the batch, Nᵢ is the total number of feasible solutions for the i-th MIP, x^{i,j} is the j-th feasible solution for the i-th MIP, x^{i,j}_{d} is the value for the d-th integer variable in the set of integer variables [symbol] in the j-th feasible solution for the i-th MIP, θ are the parameters of the neural networks, p_{θ}(x^{i,j}_{d}|Mᵢ) is the probability assigned by the neural networks to x^{i,j}_{d} by processing an input representation of Mᵢ, y^{i,j}_{d} is the assignment probability assigned to the d-th integer variable in the set of integer variables [symbol] in the j-th feasible solution for the i-th MIP by the assignment head being trained to have an expected coverage C, λ is a hyperparameter, and Ψ is a penalty term, e.g., a quadratic penalty term.

When there are multiple assignment, prediction heads, or both the system can train multiple sets of models simultaneously with multiple different values of C. For example, the system can train each pair of assignment-prediction heads using a corresponding value of C and then backpropagate gradients into the encoder that is shared between all of the pairs.

While the above description describes that the assignment probabilities and the value probabilities, i.e., the probabilities generated by the prediction head, are generated independently for each variable in the proper subset, in some cases, the system auto-regressively generates the value probabilities according to some ordering of the variables in the proper subset so that the value probability for a given variable depends on the value probabilities for the variables ahead of the given variable in the ordering. For example, the system can order the variables randomly, according to the order in which they are identified in the parameter data for the MIP, according to the objective coefficients for each of the variables, or according to the respective fractionalities of the variables as determined by the heuristic-based solver.

The system can generate the value probabilities auto-regressively in any of variety of ways. For example, the prediction head can be an auto-regressive neural network, e.g., an LSTM or a Transformer, that sequentially processes the embeddings to generate the value probabilities. As another example, the system can only provide auto-regressive dependencies through incrementally solving the underlying LP (linear program) problem as variable values are sampled and assigned. The underlying LP problem is the problem which would result by removing from the original optimization problem the constraint that some of the variables are integers. The optimization with this constraint removed is called an “LP relaxation”. That is, in these examples, the prediction head is still an MLP, but the input to the MLP includes, for each given variable, data specifying an assignment for the MLP generated by the heuristic-based solver with some or all of the values of the variables ahead of the given variable in the order being constrained based on the additional constraints generated for those variables. For example, the system can execute the MLP solver after every K variables in the order and the input for each given variable can include the embedding for the given variable and the assignment computed as a result of the most recent execution of the MLP solver.

FIG. 5 is a flow diagram of an example process 500 for generating optimality gap data for an MIP. For convenience, the process 500 will be described as being performed by a system of one or more computers located in one or more locations. For example, a MIP solver system, e.g., the MIP solver system 100 of FIG. 1, appropriately programmed, can perform the process 500.

In particular, the optimality gap data defines an optimality gap proof for the final assignment that was generated using the process 300.

To generate the optimality gap proof, the system generates the optimality gap data using a branch-and-bound technique that recursively, over a plurality of steps, generates a search tree with partial integer assignments at each node of the search tree.

At each step of the branch-and-bound technique, the system selects a leaf node of the current search tree from which to branch (step 502). The system can select this node using an appropriate MIP diving technique.

The system determines whether to expand the selected leaf node (step 504). For example, the system can solve an LP relaxation that constrains the ranges of the fixed variables at that node to their assigned values. This solution gives a valid lower bound on the true objective value of any further child nodes from the selected leaf node. If this bound is larger than a known feasible assignment, then the system determines not to expand the leaf node and prune this part of the search tree since no optima for the original problem can exist in the subtree from that node. If the bound is not larger, the system determines to expand the selected leaf node.

In response to determining to expand the selected leaf node, the system selects a variable from a set of unfixed variables (i.e. variables without assigned values) at the selected leaf node.

To select the variable, the system generates a new input representation of a sub-MIP defined by the selected leaf node, i.e., as described above with reference to FIGS. 1 and 2 (step 506). The sub-MIP is the smaller MIP which results from applying the corresponding partial assignments to the original MIP defined by the parameter data.

The system then processes the new input representation using a second encoder neural network to generate a respective embedding for each of the unfixed variables (set 508). The second encoder neural network generally has the same architecture as the encoder neural network described above that is used to determine the final assignment. In some implementations, the two neural networks are the same neural network, i.e., have the same parameter values that were determined through training the encoder neural network as described above. In some other implementations, the second encoder neural network has different parameter values, as will be described in more detail below.

The system then processes the respective embeddings using a branching neural network to generate a respective branching score for each of the unfixed variables and selects the variable using the respective branching scores (step 510).

The system then expands the search tree by adding two child nodes to the search tree that each have a different “domain” (range) for the selected variable (step 512). The different domains may be that for one of the nodes the selected variable is constrained to be greater than or equal to a ceiling of an LP relaxation value for the selected variable at the parent node, while for the other node the selected variable is constrained to be less than or equal to the floor of its LP relaxation value for the selected variable at the parent node.

In response to determining not to expand the search tree (in step 504), the system terminates the current step of the branch-and-bound technique, i.e., returns to step 502.

The system can train the branching neural network and, optionally, the second encoder neural network using imitation learning. As a particular example, the system can train the two neural networks to generate branching decisions that imitate those generated by an expert policy. For example, the expert policy can be a node-efficient, but computationally expensive, expert that would be too computationally intensive to deploy at inference time.

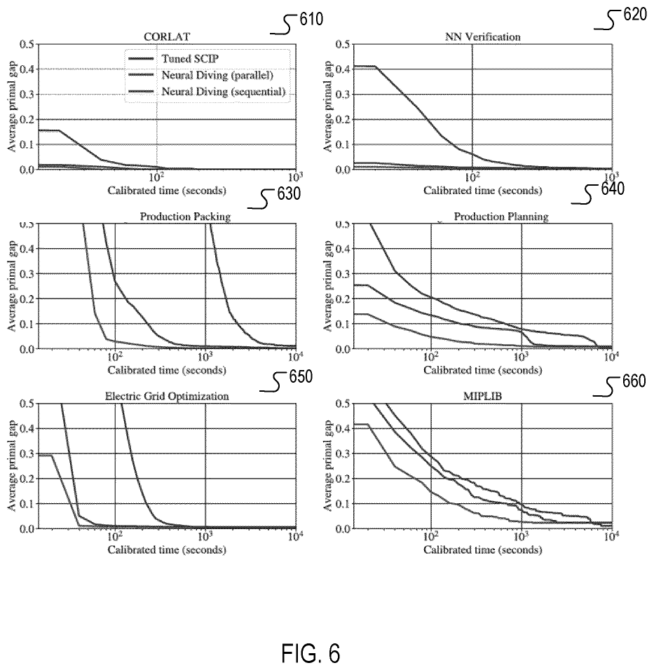

FIG. 6 shows the performance of the described techniques relative to another MIP solving technique on a variety of MIP solving tasks.

In particular, FIG. 6 shows six plots showing the performance of the described techniques relative to a conventional state-of-the-art heuristic-based technique—a “Tuned SCIP” technique that uses the SCIP heuristic-based solver with hyperparameters tuned for the particular task. Each plot shows two variants of the described techniques: “Sequential Neural Diving,” where the generation of the partial assignments and the generation of the candidate final solutions are performed sequentially for the partial assignments, and “Parallel Neural Diving,” where the generation of the partial assignments and the generation of the candidate final solutions are performed in parallel for each partial assignment, with each partial assignment being assigned to a different computer.

Each plot shows the average primal gap between the primal bound and the best known objective value achieved by the various algorithms as a function of running time on the corresponding dataset, i.e., so that a smaller average primal gap indicates a better performing solution that more closely achieves the best known objective value.

Plot 610 shows the performance on a CORLAT task that requires constructing a wildlife corridor for grizzly bears by solving an MIP.

Plot 620 shows the performance on a neural network verification task that requires verifying whether a neural network is robust to input perturbation by solving an MIP.

Plot 630 shows the performance on a production packing task that requires assigning storage locations to a shard of a database within a data center by solving an MIP.

Plot 640 shows the performance on a production planning task that requires assigning data center capacity to different software services by solving an MIP.

Plot 650 shows the performance on an electric grid optimization task that optimizes the choice of power generators to use at different time intervals during a day to meet electricity demand by solving an MIP.

Plot 660 shows the performance on a MIPLIB task. MIPLIB is a heterogeneous dataset containing ‘hard’ instances of MIPs across many different application areas.

As can be seen from the plots 610-660, both sequential and parallel Neural Diving significantly improve over Tuned SCIP across all time intervals, with the parallelization employed by parallel Neural Diving providing significant time savings over the sequential Neural Diving approach for many of the tasks. That is, because the described techniques are designed to leverage parallel processing hardware, the parallel Neural Diving approach significantly improves both over a state-of-the-art conventional technique and over the sequential version of the described techniques.

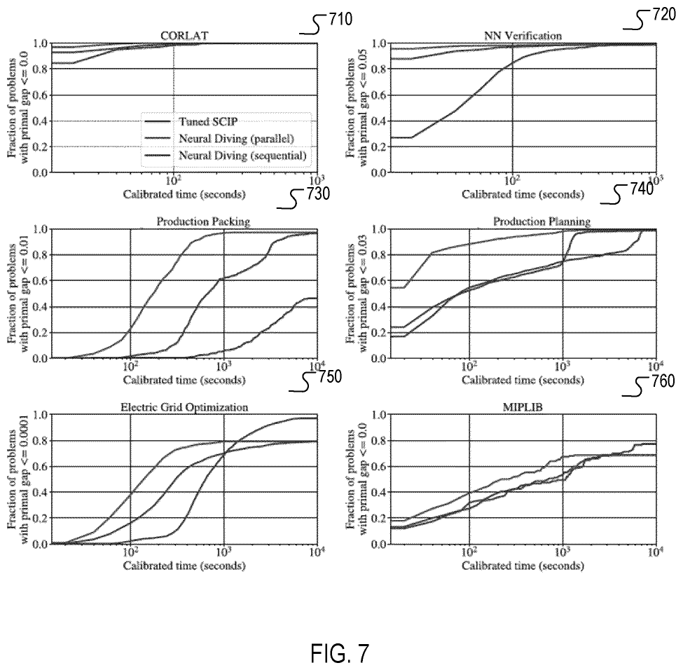

FIG. 7 also shows the performance of the described techniques relative to the other MIP solving technique on the same set of MIP solving tasks.

In particular, FIG. 7 shows six plots showing the performance of the “Tuned SCIP” technique, the “Sequential Neural Diving” technique, and the “Parallel Neural Diving” technique.

Each plot shows the fraction of instances with primal gap (relative to a known solution) less than or equal to a target gap achieved by the various algorithms at multiple time points, i.e., so that a larger fraction of instances indicates a better performing solution that more closely achieves the best known objective value at a given time point.

Plot 710 shows the performance on the CORLAT task, plot 720 shows the performance on the neural network verification task, plot 730 shows the performance on the production packing task, plot 740 shows the performance on the production planning task, plot 750 shows the performance on the electric grid optimization task, and plot 760 shows the performance on the MIPLIB task.

As can be seen from the plots 710-760, while on some tasks Tuned SCIP eventually catches up to or exceeds the fraction achieved by both sequential and parallel Neural Diving, parallel Neural Diving much more quickly achieves a high fraction of quality solutions than tuned SCIP on all tasks. That is, because the described techniques are designed to leverage parallel processing hardware, the parallel Neural Diving approach can more quickly consistently generate high quality solutions, e.g., on tasks where low latency solutions are required.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining data specifying parameters of a mixed integer program (MIP) that requires assigning respective values to each of a plurality of variables to minimize an objective subject to a set of constraints, wherein a first subset of the plurality of variables are constrained to be integer-valued;
generating, from the parameters of the MIP, an input representation;
processing the input representation using an encoder neural network to generate a respective embedding for each of the variables in the first subset;
generating a plurality of partial assignments, comprising, for each of the partial assignments:
selecting a respective second, proper subset of the first subset of variables; and
for each of the variables in the respective second subset, generating, using at least the respective embedding for the variable, a respective additional constraint on the value of the variable;
generating, for each of the plurality of partial assignments, a corresponding candidate final assignment that assigns a respective value to each of the plurality of variables starting from the additional constraints in the partial assignment; and
selecting, as a final assignment for the MIP, a candidate final assignment that (i) is a feasible solution to the MIP and (ii) has a smallest value of the objective of any of the candidate final assignments that are feasible solutions to the MIP.

2. The method of claim 1, wherein the first subset is a proper subset of the plurality of variables.

3. The method of claim 1, wherein generating, for each of the plurality of partial assignments, a corresponding candidate final assignment comprises generating the corresponding candidate final assignments in parallel.

4. The method of claim 1, wherein the plurality of partial assignments are generated in parallel by respective neural networks which are configured to operate in parallel.

5. The method of claim 1, wherein generating, for each of the plurality of partial assignments, a corresponding candidate final assignment comprises generating the corresponding candidate final assignment using a heuristic-based MIP solver conditioned on the parameters of the MIP and the additional constraints in the partial assignment.

6. The method of claim 1, wherein generating, from the parameters of the MIP, an input representation comprises:
generating, from the parameters of the MIP, a representation of a bipartite graph, the bipartite graph having:
(i) a plurality of nodes that include a first set of variable nodes each representing one of the plurality of variables and a second set of constraint nodes each representing one of the constraints,
(iii) for each constraint node, a respective edge from the constraint node to each variable node that represents a variable that appears in the constraint represented by the constraint node, and the representation comprising:
respective features for each of the plurality of nodes, and
an adjacency matrix that represents connectivity between the variable nodes and the constraint nodes in the bipartite graph.

7. The method of claim 6, wherein:
the encoder neural network is a graph neural network that is configured to process the features for each of the plurality of nodes through a sequence of one or more graph layers to generate the embeddings for the variables in the first subset;
each graph layer is configured to receive as input a respective input embedding for each of the nodes in the graph and generate as output a respective output embedding for each of the nodes in the graph;
the input embedding for each of the nodes in the graph for the first graph layer in the sequence includes the features for the nodes; and
the embedding for each of the nodes in the first subset is the output embedding generated by the last graph layer in the sequence for the node representing the variable in the first subset.

8. The method of claim 7, wherein each graph layer is configured to:
apply an update function to each of the input embeddings to generate an updated embedding; and
apply the adjacency matrix to the updated embeddings to generate initial output embeddings.

9. The method of claim 8, wherein the initial output embeddings are the output embeddings for the graph layer.

10. The method of claim 8, wherein each graph layer is configured to:
combine the initial output embeddings generated by the graph layer and the input embeddings for the graph layer to generate the output embeddings for the graph layer.

11. The method of claim 8, wherein the update function is a multi-layer perceptron (MLP).

12. The method of claim 6, wherein the adjacency matrix is an N×N matrix, wherein N is a total number of nodes in the graph, and wherein an entry (i,j) is:
equal to 1 if a node with index i is connected to a node with index j by an edge; and
equal to 0 if i is not equal to j and if the node with index i is not connected to the node with index j by an edge.

13. The method of claim 6, wherein the adjacency matrix is an N×N matrix, wherein N is a total number of nodes in the graph, and wherein the entries in the adjacency matrix represent normalized coefficients in the constraints.

14. The method of claim 1, wherein, for a particular partial assignment, the second subset includes a particular variable that is constrained to be a binary variable, and wherein generating the additional constraint for the binary variable comprises:
generating, by processing at least the respective embedding for the binary variable using a prediction neural network head, a probability for the binary variable;
sampling a value for the binary variable according to the probability; and
generating an additional constraint that constrains the value of the binary variable to be equal to the sampled value.

15. The method of claim 1, wherein the first subset includes a particular variable that is constrained to be a binary variable, and wherein, for a particular partial assignment selecting the respective second, proper subset comprises:
generating, by processing at least the respective embedding for the binary variable using a corresponding assignment neural network head, an assignment probability for the binary variable; and
determining whether to include the binary variable in the respective second subset in accordance with the assignment probability.

16. The method of claim 15, wherein different ones of the partial assignments are associated with different corresponding assignment neural network heads that have been trained to generate assignment probabilities that result in different expected coverages of the first subset.

17. The method of claim 1, wherein, for a particular partial assignment, the second subset includes a particular variable that is constrained to be a general integer variable that can take more than two possible values, and wherein generating the additional constraint for the general integer variable comprises:
generating, by processing at least the respective embedding for the general integer variable using a prediction neural network head, a respective probability for one or more of the bits in a sequence of bits that represents a cardinality of the general integer variable;
sampling a respective value for each of the one or more bits according to the probability for the bit; and
generating an additional constraint that constrains the value of the general integer variable based on the sampled values.

18. The method of claim 17, wherein the one or more bits include all of the bits in the sequence, wherein the sampled values define a single value for the general integer variable, and wherein the additional constraint constrains the general integer to have the single value.

19. The method of claim 17, wherein the one or more bits include only a proper subset of the bits in the sequence that includes the one or more most significant bits in the sequence, wherein the sampled values define a range of values for the general integer variable, and wherein the additional constraint constrains the general integer to have a value that is in the range of values defined by the sampled values for the most significant bits.

20. The method of claim 17, wherein, for the particular partial assignment selecting the respective second, proper subset comprises:
generating, by processing at least the respective embedding for the general integer variable using a corresponding assignment neural network head, a respective assignment probability for each of one or more bits in the sequence of bits; and
determining whether to include the general integer variable in the respective second subset in accordance with the assignment probability for the most significant bit in the sequence.

21. The method of claim 20, further comprising determining how many bits to include in the one or more bits for which values are sampled based on the respective assignment probabilities.

22. The method of claim 20, wherein different ones of the partial assignments are associated with different corresponding assignment neural network heads that have been trained to generate assignment probabilities that result in different expected coverages of the first subset.

23. The method of claim 1, wherein the encoder neural network is trained on feasible solutions to a data set of training MIPs generated by a heuristic-based MIP solver.

24. The method of claim 1, further comprising:
generating optimality gap data defining an optimality gap proof for the final assignment.

25. The method of claim 24, wherein generating the optimality gap data comprises:
generating the optimality gap data using a branch-and-bound technique that recursively, over a plurality of steps, generates a search tree with partial integer assignments at each node of the search tree, wherein generating the search tree comprises, at each step:
selecting a leaf node of the current search tree from which to branch;
determining whether to expand the selected leaf node; and
in response to determining to expand the selected leaf node:
selecting a variable from a set of unfixed variables at the selected leaf node; and
expanding the search tree by adding two child nodes to the search tree that each have a different domain for the selected variable.

26. The method of claim 25, wherein selecting a variable from a set of unfixed variables at the selected leaf node comprises:
generating a new input representation of a sub-MIP defined by the selected leaf node;
processing the new input representation using a second encoder neural network to generate a respective embedding for each of the unfixed variables;
processing the respective embeddings using a branching neural network to generate a respective branching score for each of the unfixed variables; and
selecting the variable using the respective branching scores.

27. The method of claim 26, wherein the branching neural network has been trained through imitation learning to imitate an expert policy that generates branching decisions for the branch-and-bound technique.

28. The method of claim 27, wherein the second encoder neural network has been trained jointly with the branching neural network.

29. The method of claim 27, wherein the second encoder neural network is the same as the encoder neural network.

30. A system comprising:
one or more computers; and
one or more storage devices storing instructions that, when executed by the one or more computers, cause the one or more computers to perform operations comprising:
obtaining data specifying parameters of a mixed integer program (MIP) that requires assigning respective values to each of a plurality of variables to minimize an objective subject to a set of constraints, wherein a first subset of the plurality of variables are constrained to be integer-valued;
generating, from the parameters of the MIP, an input representation;
processing the input representation using an encoder neural network to generate a respective embedding for each of the variables in the first subset;
generating a plurality of partial assignments, comprising, for each of the partial assignments:
selecting a respective second, proper subset of the first subset of variables; and
for each of the variables in the respective second subset, generating, using at least the respective embedding for the variable, a respective additional constraint on the value of the variable;
generating, for each of the plurality of partial assignments, a corresponding candidate final assignment that assigns a respective value to each of the plurality of variables starting from the additional constraints in the partial assignment; and
selecting, as a final assignment for the MIP, a candidate final assignment that (i) is a feasible solution to the MIP and (ii) has a smallest value of the objective of any of the candidate final assignments that are feasible solutions to the MIP.

31. One or more computer-readable storage media storing instructions that when executed by one or more computers cause the one or more computers to perform operations comprising:
obtaining data specifying parameters of a mixed integer program (MIP) that requires assigning respective values to each of a plurality of variables to minimize an objective subject to a set of constraints, wherein a first subset of the plurality of variables are constrained to be integer-valued;
generating, from the parameters of the MIP, an input representation;
processing the input representation using an encoder neural network to generate a respective embedding for each of the variables in the first subset;
generating a plurality of partial assignments, comprising, for each of the partial assignments:
selecting a respective second, proper subset of the first subset of variables; and
for each of the variables in the respective second subset, generating, using at least the respective embedding for the variable, a respective additional constraint on the value of the variable;
generating, for each of the plurality of partial assignments, a corresponding candidate final assignment that assigns a respective value to each of the plurality of variables starting from the additional constraints in the partial assignment; and
selecting, as a final assignment for the MIP, a candidate final assignment that (i) is a feasible solution to the MIP and (ii) has a smallest value of the objective of any of the candidate final assignments that are feasible solutions to the MIP.
